(19) United States
(12) Patent Application Publication
(10) Pub. No.: US 2026/0270344 A1
(43) Pub. Date: Sep. 10, 2026

(54) DISCREET CALL HANDLING BASED ON USER ENVIRONMENT

(71) Applicant: Motorola Mobility LLC, Chicago, IL (US)

(72) Inventors: Amit Kumar Agrawal, Bangalore (IN); Panduranga Reddy Pailla, Bangalore (IN); Vijayprakash Idlur, Bangalore (IN)

(73) Assignee: Motorola Mobility LLC, Chicago, IL (US)

(21) Appl. No.: 19/075,282

(22) Filed: Mar. 10, 2025

(51) Int. Cl. H04M 3/436; H04M 3/42

(52) U.S. Cl. CPC H04M 3/436; H04M 3/42059

(57) ABSTRACT

In aspects of a discreet call handling based on user environment, a mobile device receives an incoming call from a caller. The mobile device determines whether the incoming call is a discreet call based on a setting set by a user of the mobile device or a caller of the incoming phone call. The mobile device determines, using data from one or more sensors of the mobile device, whether a user of the mobile device is in a discreet environment. In response to a determination that the user is in a discreet environment, the mobile device generates a notification of the discreet call on the mobile device. In response to a determination that the user is not a discreet environment, the mobile device queues the discreet call without generating a notification on the mobile device.

### BACKGROUND

Mobile devices have become ubiquitous in modern society, serving as tools for communication, productivity, and entertainment. These devices often include various sensors and capabilities that enable them to understand and respond to their environment. For example, smartphones often include microphones, cameras, and proximity sensors to detect ambient sounds, visual information, and nearby objects. Additionally, mobile devices frequently support multiple communication channels, such as voice calls, video calls, and text messaging, allowing users to stay connected in diverse situations.

### BRIEF DESCRIPTION OF THE DRAWINGS

Implementations of the techniques for discreet call handling based on user environment are described with reference to the following Figures. The same numbers may be used throughout to reference like features and components shown in the Figures:

FIG. 1 illustrates an example communication system for discreet call handling based on the user environment in accordance with one or more implementations as described herein.

FIG. 2 illustrates an example system in which aspects of managing discreet call notifications on a mobile device are provided in accordance with one or more implementations as described herein.

FIG. 3 illustrates a flow diagram of an example procedure for handling discreet calls based on the user environment in accordance with one or more implementations as described herein.

FIG. 4 illustrates an example method for receiving discreet calls in accordance with one or more implementations as described herein.

FIG. 5 illustrates an example method for placing discreet calls in accordance with one or more implementations as described herein.

FIG. 6 illustrates various components of an example device that may be used to implement the techniques for discreet call handling based on the user environment as described herein.

### DETAILED DESCRIPTION

Implementations of the techniques for discreet call handling based on user environment may be implemented as described herein. A mobile device, such as any wireless device, media device, mobile phone, flip phone, client device, tablet, computer, communication device, entertainment device, gaming device, media playback device, and/or any other type of electronic device, or a system of any combination of such devices, may be configured to perform techniques for discreet call handling based on user environment as described herein. For example, a mobile device implements a communications application to manage incoming calls for a user of the mobile device based on a current environment. A mobile device includes a discreet call module in one or more implementations, which can implement aspects of the techniques described herein.

Mobile devices have become prevalent in modern society, serving as essential communication, productivity, and entertainment tools. The increasing use of smartphones has transformed how individuals interact, enabling constant connectivity across various media and communication channels. Such mobile devices offer numerous benefits, including instant communication, access to information, and the ability to manage personal and professional tasks on the go. As mobile technology advances, smartphones have incorporated sophisticated sensors and processing capabilities, allowing them to understand better and respond to user environments. Global events such as pandemics have further emphasized the importance of mobile communication, accelerating the adoption of remote work practices and increasing reliance on mobile devices for personal and professional interactions.

Conventional techniques for handling incoming calls on mobile devices may not adequately address the challenge of maintaining privacy and minimizing disruptions in various social and professional contexts. For example, users may receive calls at inopportune moments, potentially causing embarrassment or interrupting meetings. Call notifications can result in awkward situations or unintended disclosure of private information. Additionally, the ability to silence or ignore calls may lead to missed communications. Furthermore, existing solutions do not provide context-aware call handling to manage incoming calls based on a user’s current environment, leading to inefficient communication management and reduced control over personal privacy.

As described herein, a mobile device implements techniques for handling incoming phone calls that may be related to discrete subject matter or topics and based on the user environment to address privacy and disruption challenges. The mobile device monitors a user’s environment using various sensors to determine if the user is in a discreet environment (e.g., alone) or not (e.g., in the presence of others). When receiving an incoming discreet call, the device analyzes the environmental context to decide whether to notify the user or queue the call without generating alerts. If the system determines that the user is in a discreet environment, a notification is provided via the user interface. If the user is not in a discreet environment, the call is queued without a visual or audio alert, maintaining the user’s privacy and preventing disruptions.

The techniques described herein offer several advantages over conventional approaches for call handling. By providing context-aware, discreet call management, the system helps prevent awkward interruptions, unintended disclosures, and disruptions that occur when calls are received in inappropriate settings. The call handling results in more efficient communication management and improved privacy control. Additionally, the mobile device’s ability to monitor the user’s environment allows for adaptive call notifications rather than relying solely on manual settings or the user’s constant attention to their device. This balanced approach enables users to receive calls when appropriate while ensuring they are not disturbed in sensitive situations, enhancing overall communication effectiveness compared to conventional techniques that lack adaptive, context-aware call handling.

Consider an example scenario where Sarah often struggles with managing personal calls during work hours, particularly in meetings or collaborative spaces. During a client meeting, she receives a call from her doctor, leading to an awkward interruption and potential privacy concerns. In another instance, she misses an urgent call from her child’s school because her phone is silenced. These scenarios highlight the challenges of conventional approaches to mobile call handling.

However, users have a more balanced and efficient experience with the discreet call-handling system described herein. The system monitors the user’s environment and the context of when incoming calls are received (e.g., based on calendar data), providing timely notifications when appropriate. The described techniques allow the user to receive calls alone while also ensuring that the user is not disturbed or exposed to privacy risks around others. Context-aware call handling includes queueing discreet calls and providing notifications later when the user is in a more suitable environment. In this way, the mobile device manages communications more effectively, avoiding awkward situations and improving privacy control.

While features and concepts of the described techniques for discreet call handling based on user environment are implemented in any number of different devices, systems, environments, and/or configurations, implementations of the techniques for discreet call handling based on user environment are described in the context of the following example devices, systems, and methods.

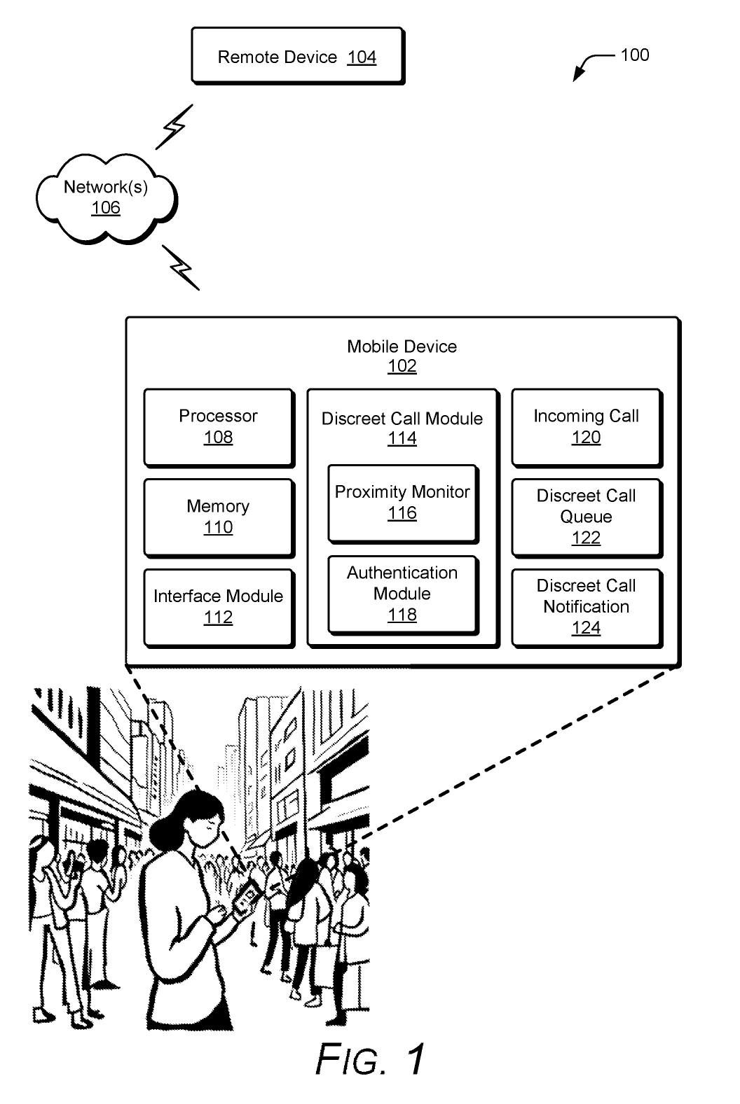

FIG. 1 illustrates an example communication system 100 for discreet call handling based on user environments in accordance with one or more implementations as described herein. The communication system 100 includes a mobile device 102 and a remote device 104, where the mobile device 102 and the remote device 104 may be communicatively connected via one or more networks 106. The remote device 104 may be remote from or independent of mobile device 102 (e.g., in a physical location different from mobile device 102, which is not collocated). Although in some instances, reference is made to a mobile device 102 and a remote device 104, respectively, in the singular, a mobile device 102 and a remote device 104 may also represent multiple different devices in some cases. The mobile device 102 and the remote device 104 may include one or more features in addition to, or as an alternative to, the features illustrated in the system 100.

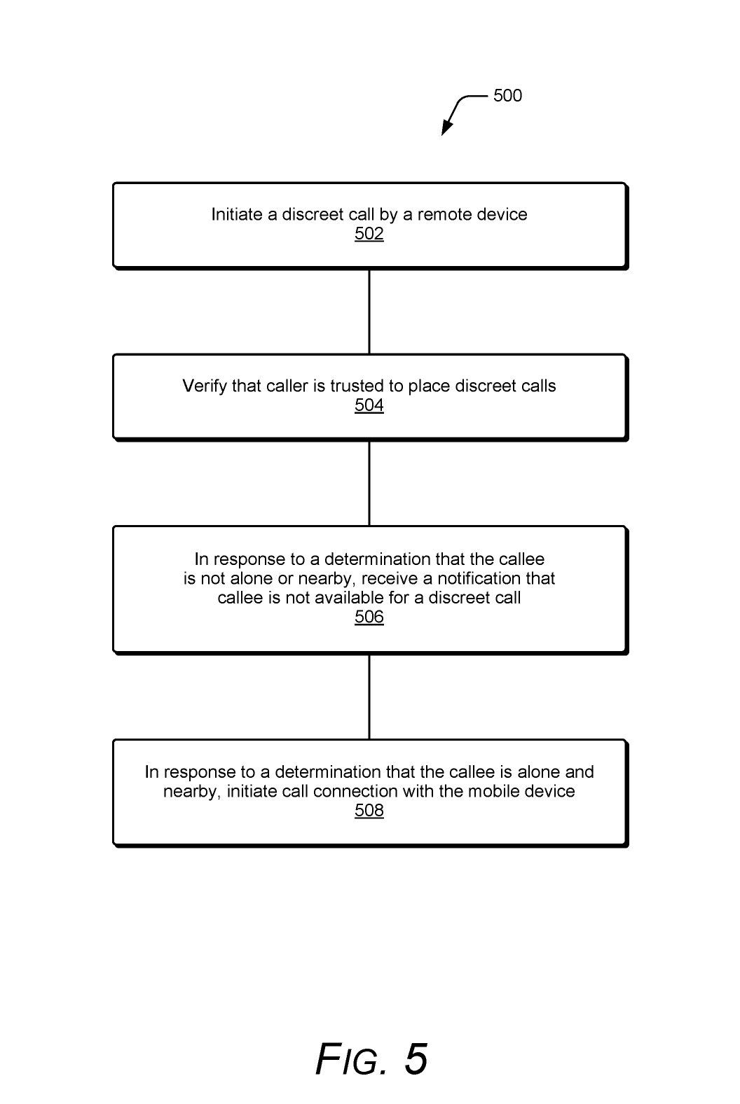

Examples of mobile device 102 and remote device 104 include at least one of any wireless device, mobile device, smartphone, mobile phone, flip phone, client device, companion device, laptop, tablet, computing device, communication device, entertainment device, gaming device, media playback device, and/or any other type of computing, consumer, or electronic device. The mobile device 102 can be implemented with various components, such as a processor 108 and memory 110, as well as any number and combination of different components as further described with reference to the example device shown in FIG. 5. The mobile device 102 may include several other components, such as an interface module 112 and a discreet call module 114, which includes a proximity monitor 116 and an authentication module 118. The processor 108 and memory 110 provide processing capabilities and storage for the mobile device 102.

In one or more implementations, the mobile device 102 and the remote device 104 include various radios for wireless communication (e.g., via network 106). For example, the mobile device 102 and the remote device 104 can include a Wi-Fi radio, a cellular radio, a Bluetooth (BT) and/or Bluetooth Low Energy (BLE) transceiver, a near-field communication (NFC) transceiver, and/or other device communication interfaces.

In some implementations, the devices, applications, modules, servers, and/or services described herein communicate via one or more communication networks, such as for data communication with the mobile device 102. For example, the communication network 106 can include a wired and/or wireless network. The communication network 106 is implemented using any network topology and/or communication protocol. The communication network 106 can be represented or otherwise implemented as a combination of two or more networks, including IP-based networks, cellular networks, and/or the Internet. The communication network 106 includes mobile operator networks managed by a mobile network operator and/or other network operators, such as a communication service provider, mobile phone provider, and/or Internet service provider.

Mobile device 102 includes various functionalities enabling the device to manage discreet calls based on a user’s environment, as described herein. In one or more examples, the interface module 112 represents functionality (e.g., logic and/or hardware) enabling the mobile device 102 to interconnect and interface with other devices (e.g., the remote device 104) and/or networks, such as the communication network 106. For example, the interface module 112 enables wireless and/or wired connectivity of the mobile device 102 to initiate calls, receive calls, and determine status information about the environment of the mobile device 102.

The mobile device 102 can include and implement various device applications, such as any type of messaging application, email application, video communication application, cellular communication application, music/audio application, gaming application, media application, social platform application, and/or any other of the many possible types of various device applications. Many device applications have an associated user interface that is generated and displayed for user interaction and viewing, such as on a display screen of the mobile device 102. Generally, an application user interface, or any other type of video, image, graphic, and the like, is digital image content that is displayable on the display screen of the mobile device 102.

In the example communication system 100 for handling discreet calls, the mobile device 102 implements the discreet call module 114 (e.g., as a device application or a portion of a communication application). As shown in this example, the discreet call module 114 represents functionality (e.g., logic, software, and/or hardware) enabling techniques for discreet call handling based on the user environment. The discreet call module 114 can be implemented as computer instructions stored on computer-readable storage media (e.g., memory 110) and executed by a processor system (e.g., the processor 108) of the mobile device 102. Alternatively, or in addition, the discreet call module 114 can be implemented at least partially in the device’s hardware. The discreet call module 114 includes a proximity monitor 116 and an authentication module 118. These components may work together to monitor the user’s environment and detect the user’s proximity.

The proximity monitor 116 monitors the environment around the mobile device 102 (e.g., within the detection range of one or more sensors of the mobile device 102) to detect the presence of the user and other individuals. The proximity monitor 116 uses various sensors to determine whether a user is near the mobile device 102 and whether the user is alone. These sensors include a microphone, camera devices, and device sensors such as thermal pile sensors to detect human presence near the device. The proximity monitor 116 can also utilize connected devices like smartwatches or earbuds to determine user proximity and aloneness.

The authentication module 118 verifies the device user’s identity. Authorized users can access and manage discreet calls on the mobile device 102. The authentication module 118 works with the proximity monitor 116 to provide a secure, privacy-focused call-handling experience.

When mobile device 102 receives an incoming call 120 from a caller, the discreet call module 114 determines whether the incoming call 120 is a discreet call. An incoming discreet call includes any type of discreet communication that prioritizes privacy and context-awareness. In some aspects, discreet calls may be initiated by trusted contacts and handled by the mobile device 102 in a manner that considers the recipient’s current environment and social situation. For example, the discreet call module 114 determines if the caller of the incoming call 120 is a trusted or favorite contact within the memory 110 of the mobile device 102. As another example, the discreet call module 114 determines whether the incoming call 120 includes a discreet call request and the discreet call module 114 then determines whether the caller is a favorite contact, a user previously identified as trusted for discreet calls, or associated with a frequent contact of the user. Examples of discreet calls may include sensitive personal communications, confidential work-related discussions, or calls from healthcare providers discussing private medical information.

The discreet call module 114 then determines the user’s environment. The communication system 100 manages these calls to minimize disruptions and protect the user’s privacy when in the presence of others. Discreet calls may be queued into a discrete call queue 122 without visible or audible notifications if the user is determined not to be in a discreet environment (e.g., alone).

If the proximity monitor 116 determines the user is in a discreet environment (e.g., alone) and the authentication module 118 determines that the user is near or authenticated on the mobile device 102, the discreet call module 114 generates a discreet call notification 124 on the mobile device 102. This discreet call notification 124 notification can be displayed on the display device of the mobile device 102 or played through the audio system of the mobile device 102, depending on the user’s preferences and the current device settings.

If the proximity monitor 116 determines that the user is not in a discreet environment, the discreet call module 114 queues the discreet call without generating a discreet call notification 124 on the mobile device 102. This ensures that the user’s privacy is maintained when the user is in the company of others or not in a discreet environment.

In cases where the proximity monitor 116 and/or authentication module 118 determines that the user is not near or authenticated on the mobile device 102, the discreet call module 114 can send a request to another device associated with the user to determine if the user is near or authenticated on that device and in a discreet environment. If the user is found to be authenticated on the other device and in a discreet environment, the mobile device 102 forwards an indication of the discreet call or the discreet call itself to the other device. This feature allows for seamless handling of discreet calls across multiple devices associated with the user.

The communication system 100 for discreet call handling provides several advantages over conventional call handling systems. For example, consider a scenario where a user is in a business meeting and receives a discreet call from their spouse regarding a sensitive family matter. With traditional systems, the call might interrupt the meeting or be missed, potentially causing stress or miscommunication. However, with the described system, the discreet call module 114 detects that the user is not in a discreet environment (e.g., around others) and queues the call without any visible or audible notification. Later, when the user is alone, the discreet call module 114 notifies the user of the queued discreet call.

In another scenario, a user might be working in a shared office space when they receive a discreet call from their doctor about confidential test results. The proximity monitor 116 can detect that the user is not in a discreet environment and prevent any notifications that might compromise the user’s privacy. When the user moves to a private area, the system can notify them of the queued call, allowing them to return it in a secure environment. This context-aware call handling level enhances privacy and communication efficiency, addressing challenges that conventional systems often struggle to manage effectively.

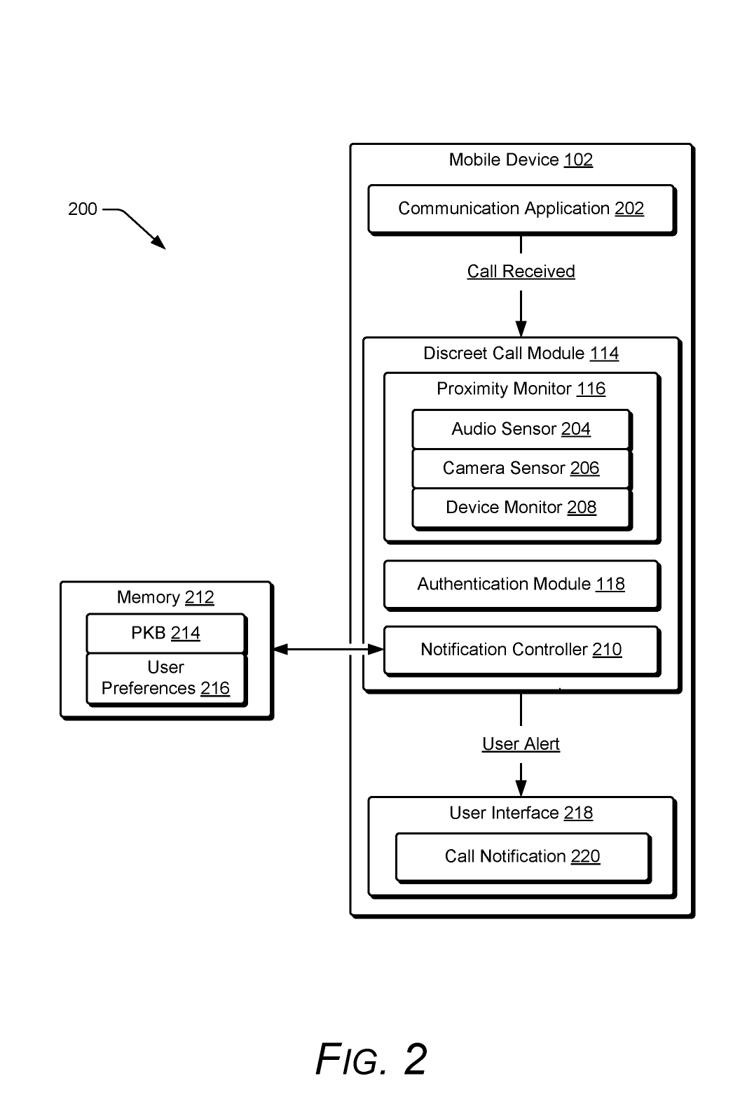

FIG. 2 illustrates an example system 200 in which aspects of managing discreet call notifications on a mobile device are provided in accordance with one or more implementations as described herein. The example system 200 may implement aspects of the example communication system 100. For example, system 200 can be implemented by a mobile device 102 with a communication application 202, the discreet call module 114, the proximity monitor 116, and the authentication module 118.

The mobile device 102 provides communication capabilities, such as telephone calls, teleconferences, or video conferences, using the communication application 202. The communication application 202 refers to software that enables users to participate in telephone calls, virtual meetings, teleconferences, video conferences, and other remote communications. When the incoming call 120 is received, the communication application 202 processes the incoming call 120 through the discreet call module 114.

The discreet call module 114 includes the proximity monitor 116 that utilizes multiple sensors to detect the user’s environment. These sensors include an audio sensor 204 for detecting ambient sounds, a camera sensor 206 for visual detection, and a device monitor 208 for monitoring connected devices. The proximity monitor 116 uses these sensors to determine whether the user is in a discreet environment or in the presence of others, e.g., by detecting an absence of voices using the audio sensor 204, an absence of persons using the camera sensor 206 or a radar sensor, and/or an absence of other devices using a wireless communication interface. The proximity monitor 116 can also analyze the environmental sounds using the audio sensor 204 to determine whether the user is in a discreet environment. For example, the proximity monitor 116 determines the level of privacy for the user for an environment within a predetermined distance (e.g., related to the sensor range of the audio sensor 204, camera sensor 206, and/or device monitor 208) around the user or the mobile device 102. As described above, the authentication module 118 verifies the user’s identity and presence.

A notification controller 210 manages how and when call notifications are presented based on the environmental conditions detected by the proximity monitor 116. As shown in this example, the notification controller 210 represents functionality (e.g., logic, software, and/or hardware) enabling techniques for adjusting the notification type, timing, and content associated with an incoming discreet call based on the user’s environment and preferences. The notification controller 210 can be implemented as computer instructions stored on computer-readable storage media (e.g., memory 212) and executed by a processor system (e.g., the processor 108) of the mobile device 102. In some implementations, the notification controller 210 may suppress visual and audible alerts when the user is determined to be in a sensitive environment, such as a meeting or public space. The notification controller 210 may also interact with other device systems, such as the display and audio systems, to ensure that notifications are presented in an appropriate and discreet manner.

The system 200 also includes a memory 212 that stores a personal knowledge base 214 and user preferences 216. The notification controller 210 interacts with the personal knowledge base 214 and user preferences 216 to determine appropriate notification settings, whether an incoming call is authorized to be a discreet call or should be handled as a discreet call, and/or thresholds for determining whether a current environment is a discreet environment. The personal knowledge base 214 refers to a collection of information specific to a user, including their name, communication history, and contacts, including trusted individuals and favorite contacts. For instance, the personal knowledge base 214 may contain details about the type of relationship between the user and certain contacts (e.g., spouse, family doctor, kids’ school) to assist with determinations of treating incoming phone calls as discreet calls. User preferences 216 include settings and choices made explicitly or implicitly by users regarding how they wish to receive or suppress notifications depending on their environment. For example, user preferences 216 store configurable settings for the discreet call module 114, such as thresholds for determining when the user is considered alone or in a discreet environment. These thresholds apply to the various sensor inputs, such as the level of ambient noise detected by the audio sensor 204 or the number of devices detected by the device monitor 208.

A user interface 218 provides the interface for user interaction and includes a call notification component that displays call information when appropriate based on determinations by the notification controller 210. The user interface 218 serves as a means of interaction between the discreet call module 114 and the user. For example, the user interface 218 can generate call notifications 220 generated by the discreet call module 114 or the notification controller 210, providing visual, audio, or tactile alerts to alert the user to an incoming discreet call when appropriate based on the user’s environment. The user interface 218 can generate a discreet visual, audio, and/or tactile alert to indicate an incoming discreet call when the user is determined to be alone or in a discreet environment. The user interface 218 can also allow users to customize their notification preferences and provide feedback on the relevance and timing of discreet calls, which can further refine a machine-learning model of the discreet call module 114 and improve its overall effectiveness.

The components are interconnected to enable communication flow between the memory 212 and the various modules within the mobile device 102. When a call is received, the system processes the environmental information and user preferences to determine whether and how to present the call notification to the user. In accordance with the described techniques, when the mobile device 102 receives an incoming discreet call, the proximity monitor 116 receives sensor data from the audio sensor 204 to detect nearby voices and analyze environmental sounds. The camera sensor 206 and device monitor 208 provide sensor data used by the proximity monitor 116 to detect the presence of nearby persons and other devices using wireless communication interfaces. Based on data from these multiple sensors, the proximity monitor 116 determines the level of privacy of the user’s environment and whether the user is in a discreet environment. The notification controller 210 then adjusts notification settings for the discreet call based on this determined privacy level.

If the proximity monitor 116 determines that the user is not alone or in a discreet environment, the notification controller 210 queues the discreet call into the discreet call queue 122 without providing an audio, tactile, and/or visual alert on the user interface 218. Queuing the discreet call involves sending the call to voicemail without ringing or providing a busy signal to the remote device 104. The mobile device 102 sends a verbal or text notification to the caller when the user cannot answer the discreet call, depending on the settings in the user preferences 216. In one implementation, this notification is sent to callers identified in the personal knowledge base 214 as trusted individuals or favorite contacts.

If the caller indicates that the call is urgent or an emergency, the notification controller 210 generates the discreet call notification 124 of the queued discreet call, even if the user is not alone or in a discreet environment. Before providing this discreet call notification 124, the authentication module 118 authenticates the user to ensure privacy.

The mobile device 102 continues to monitor the environment using the proximity monitor 116 to determine when the user becomes alone or enters a discreet environment after initially not being in one. When the user is subsequently determined to be in a discreet environment, the notification controller 210 generates a notification of the queued discreet call as the call notification 220 of the user interface 218. The mobile device 102 then prompts the user to initiate a textual message or another discreet call to the caller. Alternatively, the mobile device 102 initiates a return call to the caller if specified in the user preferences 216.

System 200 allows the caller to set a parameter or metadata indicating that the call rings if the recipient is in a discreet environment. When such a call is received, the communication application 202 passes this information to the discreet call module 114, which then ensures that visual, tactile, and audio alerts are suppressed on the mobile device 102 if the user is not alone or in a discreet environment. The example system 200 for managing discreet call notifications provides a comprehensive approach to handling incoming discreet calls based on the user’s environment, ensuring privacy and minimizing disruptions while maintaining communication capabilities.

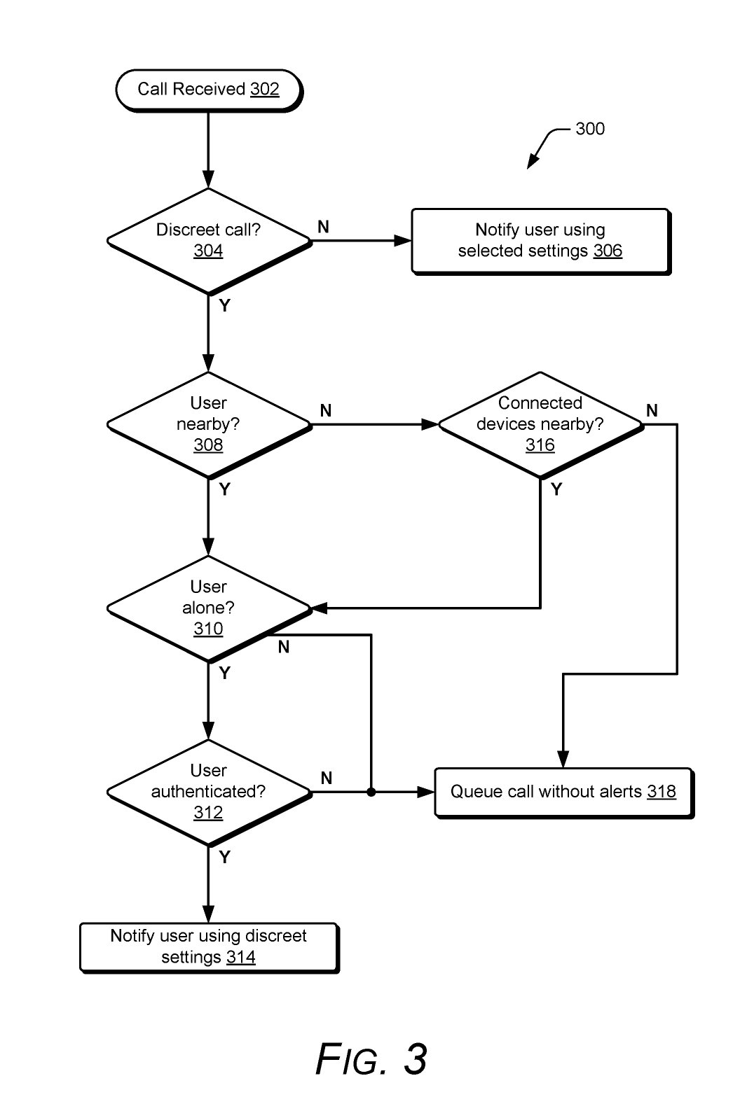

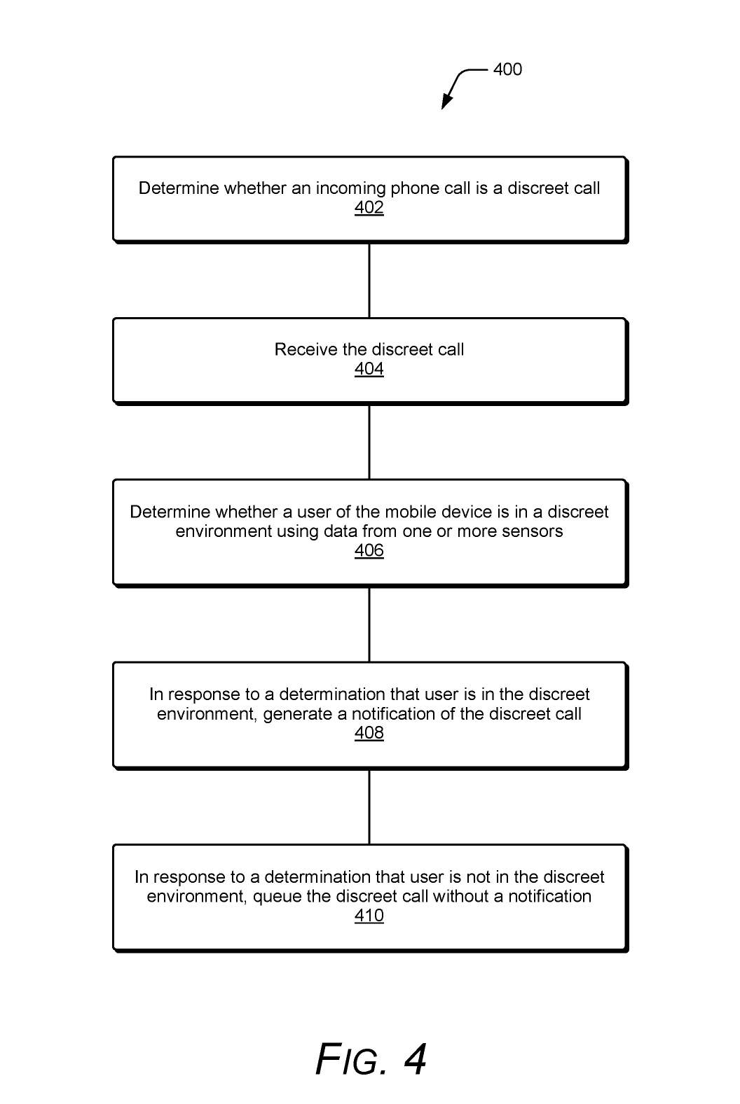

FIG. 3 illustrates a flow diagram of an example procedure 300 for handling incoming calls based on user environment and presence detection. In some aspects, any services, components, modules, methods, and/or operations described herein for FIGS. 3, 4, and/or 5, may be implemented using software, firmware, hardware (e.g., fixed logic circuitry), manual processing, or any combination thereof. Some operations of the example procedure 300 and/or methods 400 and/or 500 may be described in the general context of executable instructions stored on computer-readable storage memory that is local and/or remote to a computer processing system, and implementations may include software applications, programs, functions, and the like. Alternatively, or in addition, any of the functionality described herein may be performed, at least in part, by one or more hardware logic components, such as, and without limitation, field-programmable gate arrays (FPGAs), application-specific integrated circuits (ASICs), application-specific standard products (ASSPs), system-on-a-chip systems (SoCs), complex programmable logic devices (CPLDs), and the like.

The order in which procedure 300 and/or methods 400 and/or 500 is described is not intended to be construed as a limitation, and any number or combination of the described operations may be performed in any order to implement the procedure or an alternate procedure.

Procedure 300 begins at 302 when the mobile device 102 receives an incoming call. The communication application 202 processes the call and passes it to the discreet call module 114 for further handling.

At 304, the discreet call module 114 determines whether the incoming call is a discreet call. This determination is based on parameters or metadata associated with the call, such as a tag indicating the caller’s preference for discreet handling. In another implementation, the determination that the incoming call is a discreet call is based on a setting set by a user of the mobile device (e.g., the called device) and whether the caller is a trusted, authorized, or favorite contact. In yet another implementation, the determination of whether an incoming call is a discreet call is a combination of the caller requesting a discreet call and the caller being a trusted, authorized, or favorite contact.

At 306, if the call is not discreet (e.g., a “no” or “N” determination at block 304), the user is notified of the incoming call using selected settings, which are notification settings stored or selected in the user preferences 216.

At 308, if the call is determined to be a discreet call (e.g., a “yes” or “Y” determination at 304), the proximity monitor 116 and/or authentication module 118 determines if the user is nearby or authenticated on the mobile device 102. The proximity monitor 116 uses data from various sensors, including the audio sensor 204, camera sensor 206, and device monitor 208, to detect the user’s presence.

At 310, if the user is determined to be near or authenticated on the mobile device 102 (e.g., a “yes” or “Y” determination at 308), the proximity monitor 116 assesses whether the user is alone or in a discreet environment. This assessment involves analyzing data from multiple sensors to determine the level of privacy in the user’s environment. The audio sensor 204 detects nearby voices and ambient noise, while the camera sensor 206 performs visual detection of other individuals. At 312, if the user is determined to be alone or in a discreet environment (e.g., a “yes” or “Y” determination at 310), the authentication module 118 verifies the user’s identity to ensure that just the authorized user receives notifications about discreet calls.

In one implementation, the discreet call module 114 analyzes calendar data associated with the user, which is stored in memory 212 or retrieved from a cloud service through network 106. The calendar analysis provides context for the user’s current and upcoming activities to refine and assist the decision-making process of the discreet call module 114. As one example, the proximity monitor 116 adjusts sensitivity thresholds to determine whether the user is in a discreet environment based on the analyzed calendar data. If the calendar indicates the user is in a meeting, the thresholds for detecting other people’s presence are lowered, making the proximity monitor 116 more likely to consider the user as not in a discreet environment. Conversely, during scheduled personal time, the thresholds are raised, allowing for more lenient determination of the user being alone or in a discreet environment.

At 314, upon successful authentication (e.g., a “yes” or “Y” determination at 312), the notification controller 210 generates a notification for the user using discreet settings. These settings of the discreet call notification 124 are designed to maintain privacy and minimize disruption, such as using subtle visual cues or haptic feedback instead of audible alerts.

In at least one implementation, the discreet call module 114 detects a pattern of environmental conditions when the user typically accepts discreet calls. The discreet call module 114 monitors and records the environmental conditions when the user accepts discreet calls over time to refine or update procedure 300. These conditions include factors such as time of day, location, ambient noise levels, and the presence of specific connected devices. The notification controller 210, for example, uses the detected pattern to refine criteria for determining when to generate notifications for incoming discreet calls. For instance, if the pattern indicates the user frequently accepts discreet calls when in a specific location, such as a home office, the discreet call module 114 adjusts its criteria to be more likely to notify the user of discreet calls when in that location, even if other environmental factors suggest the user is not alone or in a discreet environment. The discreet call module 114 continuously updates the pattern recognition model stored in memory 212, improving its ability to predict when the user will likely be receptive to discreet call notifications.

At 316, if the user is not nearby (e.g., a “no” or “N” determination at 308), the mobile device 102 checks if any connected devices are in the vicinity. The device monitor 208 scans for connected devices such as smartwatches or wireless earbuds associated with the user. If connected devices are detected, the flow returns to 310 to determine if the user is in a discreet environment.

At 318, if the user is determined not to be in a discreet environment, not near any devices associated with the user, or not authenticated (e.g., a “no” or “N” determination at 310, 312, or 316), the discreet call module 114 queues the call without generating alerts. The call is stored in the discreet call queue 122 in the memory 212 for later notification when conditions become suitable.

FIG. 4 illustrates an example method 400 for handling discreet call in accordance with one or more implementations of the techniques described herein.

At 402, it is determined whether an incoming call is a discreet call. For example, the discreet call module 114 determines whether the incoming call 120 is a discreet call based on parameters or metadata associated with the call. Such metadata includes a tag or bit indicating the caller’s preference for discreet handling. In another implementation, the determination that the incoming call 120 is a discreet call is based on a setting set by a user of the mobile device (e.g., the called device) and whether the caller is a trusted, authorized, or favorite contact. In yet another implementation, the determination of whether an incoming call is a discreet call is a combination of the caller requesting a discreet call and the caller being a trusted, authorized, or favorite contact. At 404, if the incoming call is a discreet call, the discreet call is received and managed (e.g., by the discreet call module 114).

At 406, it is determined whether the user of the mobile device is in a discreet environment using data from one or more sensors. For example, the discreet call module 114 analyzes data from multiple sensors to determine the level of privacy in the user’s environment. The audio sensor 204 detects nearby voices and ambient noise, while the camera sensor 206 performs visual detection of other individuals. At 408, if the user is determined to be alone or in a discreet environment, a notification of the discreet call is generated. For example, the discreet call module 114 generates the discreet call notification 124. At 410, if the user is not determined to be in a discreet environment, the discreet call is queued (e.g., placed in the discreet call queue 122) without an audio or visual notification.

FIG. 5 illustrates an example method 500 for placing discreet calls in accordance with one or more implementations of the techniques described herein.

At 502, a request to initiate a discreet call with a mobile device associated with a user is received by a remote mobile device. By way of example, the remote device 104 receives a request for a discreet call to be placed to the mobile device 102. The request is processed by a communication application and passed to a discreet call module for further handling.

At 504, the discreet call request is verified. By way of example, the discreet call module on the remote device 104 verifies that a discreet call authorization is stored in the memory before transmitting the request for the discreet call. The verification ensures that authorized contacts initiate discreet calls, maintaining privacy and security of the user of the mobile device 102.

At 506, the discreet call request is transmitted to the mobile device. For example, the remote device 104 transmits the request for the discreet call to the mobile device 102 through the network 106 using an interface module. At 508, a response to the discreet call request is received. In one scenario, the remote device 104 receives an indication that the discreet call is being placed on the mobile device 102, which occurs when the discreet call module 114 on the mobile device 102 determines that remote user is in a discreet environment for receiving the discreet call.

In another scenario, the remote device 104 receives a notification that the user is not in a discreet environment and that the discreet call has been queued. This notification is received in response to the mobile device 102 determining that the user is not alone or in a private setting. In at least one implementation, when the remote device 104 receives a notification that the user is not in a discreet environment, the discreet call module prompts the remote user (e.g., via display on the user interface) to indicate if the discreet call is an emergency or urgent phone call. Additionally, or alternatively, the discreet call module provides a prompt for sending a text message or an audio message to the mobile device 102 when the mobile device 102 is subsequently in a discreet environment, allowing the user to communicate with the remote user even when an immediate discreet call is not possible.

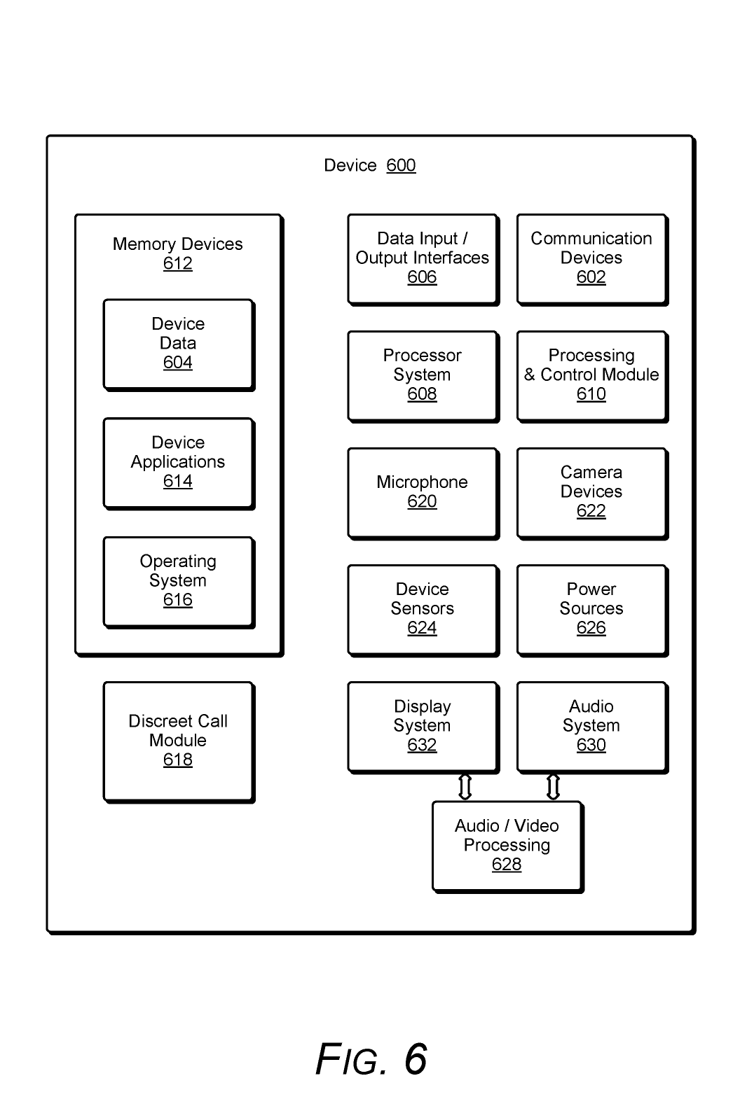

FIG. 6 illustrates various components of an example device 600, which can implement aspects of the techniques and features for discreet call handling based on user environment, as described herein. The example device 600 may be implemented as any of the devices described with reference to the previous FIGS. 1-5, such as any type of wireless device, mobile device, mobile phone, flip phone, client device, companion device, display device, tablet, computing, communication, entertainment, gaming, media playback, and/or any other type of computing and/or electronic device. For example, the mobile device 102 described with reference to FIGS. 1-5 may be implemented as the example device 600.

The example device 600 can include various, different communication devices 602 that enable wired and/or wireless communication of device data 604 with other devices. The device data 604 can include any of the various device data and content that is generated, processed, determined, received, stored, and/or communicated from one computing device to another. Generally, the device data 604 can include any form of audio, video, image, graphics, and/or electronic data generated by applications executing on a device. The communication devices 602 can also include transceivers for cellular phone communication and/or for any type of network data communication.

The example device 600 can also include various and different types of data input/output (I/O) interfaces 606, such as data network interfaces that provide connection and/or communication links between the devices, data networks, and other devices. The data I/O interfaces 606 may be used to couple the device to any type of components, peripherals, and/or accessory devices, such as a computer input device that may be integrated with the example device 600. The I/O interfaces 606 may also include data input ports via which any type of data, information, media content, communications, messages, and/or inputs may be received, such as user inputs to the device, as well as any type of audio, video, image, graphics, and/or electronic data received from any content and/or data source.

The example device 600 includes a processor system 608 of one or more processors (e.g., any of microprocessors, controllers, and the like) and/or a processor and memory system implemented as a system-on-chip (SoC) that processes computer-executable instructions. The processor system 608 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits 610. The example device 600 may also include any type of a system bus or other data and command transfer system that couples the various components within the device. A system bus can include any one or combination of different bus structures and architectures, as well as control and data lines.

The example device 600 also includes memory and/or memory devices 612 (e.g., computer-readable storage memory) that enable data storage, such as data storage devices implemented in hardware that may be accessed by a computing device and that provide persistent storage of data and executable instructions (e.g., software applications, programs, functions, and the like). Examples of memory devices 612 include volatile memory and non-volatile memory, fixed and removable media devices, and any suitable memory device or electronic data storage that maintains data for computing device access. The memory devices 612 can include various implementations of random-access memory (RAM), read-only memory (ROM), flash memory, and other types of storage media in various memory device configurations. The example device 600 may also include a mass storage media device.

Memory devices 612 (e.g., computer-readable storage memory) provide data storage mechanisms, such as storing device data 604, other types of information and/or electronic data, and various device applications 614 (e.g., software applications and/or modules). For example, an operating system 616 may be maintained as software instructions with a memory device 612 and executed by the processor system 608 as a software application. The device applications 614 may also include a device manager, such as any form of a control application, software application, signal-processing and control module, code specific to a particular device, a hardware abstraction layer for a particular device, and so on.

In this example, the device 600 includes a discreet call module 618 that implements various aspects of the features and techniques described herein. The discreet call module 618 may be implemented with hardware components and/or in software as one of the device applications 614, such as when the example device 600 is implemented as the mobile device 102 described with reference to FIGS. 1-5. An example of the discreet call module 618 is the discreet call module 114 implemented by the mobile device 102, such as a software application and/or as hardware components in the mobile device. In implementations, the discreet call module 618 may include independent processing, memory, and logic components as a computing and/or electronic device integrated with the example device 600.

The example device 600 can also include a microphone 620 (e.g., to capture audio and/or an audio recording) and/or camera devices 622 (e.g., to capture digital images and/or video images), as well as device sensors 624, such as may be implemented as components of an inertial measurement unit (IMU). The device sensors 624 may be implemented with various sensors, such as a gyroscope, an accelerometer, and/or other types of motion sensors to sense the motion of the device. The device sensors 624 can generate sensor data vectors having three-dimensional parameters (e.g., rotational vectors in x, y, and z-axis coordinates) indicating the location, position, acceleration, rotational speed, and/or orientation of the device. The example device 600 can also include one or more power sources 626, such as when the device is implemented as a wireless device and/or a mobile device. The power sources may include a charging and/or power system, and may be implemented as a flexible strip battery, a rechargeable battery, a charged super-capacitor, and/or any other type of active or passive power source.

The example device 600 can also include an audio and/or video processing system 628 that generates audio data for an audio system 630 and/or generates display data for a display system 632. The audio system 630 and/or the display system 632 may include any types of devices or modules that generate, process, display, and/or otherwise render audio, video, display, and/or image data. Display data and audio signals may be communicated to an audio component and/or to a display component via any type of audio and/or video connection or data link. In implementations, the audio system 630 and/or the display system 632 are integrated components of the example device 600. Alternatively, the audio system 630 and/or the display system 632 are external, peripheral components to the example device.

Although implementations for real-time user notifications in virtual meetings have been described in language specific to features and/or methods, the appended claims are not necessarily limited to the specific features or methods described. Rather, the specific features and methods are disclosed as example implementations for real-time user notifications in virtual meetings, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

A mobile device comprising: at least one memory and at least one processor coupled with the at least one memory and configured to cause the mobile device to: determine that an incoming phone call is a discreet call based on a setting set by a user of the mobile device or a caller of the incoming phone call, determine, using data from one or more sensors of the mobile device, whether a user of the mobile device is in a discreet environment, and in response to a determination that the user is in the discreet environment, generate a notification of the discreet call on the mobile device; or in response to a determination that the user is not in the discreet environment, queue the discreet call without generating a visual notification or an audio notification on the mobile device.

A mobile device wherein the at least one processor is configured to cause the mobile device to: in response to queueing the discreet call, subsequently determine whether the user is in the discreet environment using data from the one or more sensors, and in response to a subsequent determination that the user is in the discreet environment, initiate a return call to the caller.

A mobile device wherein the at least one processor is configured to cause the mobile device to: determine a level of privacy of an environment within a predetermined distance around the user based on data from the one or more sensors and adjust notification settings for the discreet call based on the determined level of privacy.

A mobile device wherein the at least one processor is configured to cause the mobile device to send a notification to the caller that the user is unable to answer the discreet call in response to queueing the discreet call.

A mobile device wherein the notification is sent to the caller in response to the caller being previously identified by the user as a trusted individual or a favorite contact.

A mobile device wherein the at least one processor is configured to cause the mobile device to generate a discreet visual notification of queuing of the discreet call in response to receiving a notification from the caller that the discreet call is urgent or an emergency phone call.

A mobile device wherein the at least one processor is configured to cause the mobile device to: determine, using the one or more sensors, whether the user is authenticated on the mobile device, and in response to a determination that the user is authenticated on the mobile device, determine whether the user of the mobile device is in the discreet environment, or in response to a determination that the user is not authenticated on the mobile device, send a request to a second device associated with the user to determine whether the user is authenticated on the second device and is in the discreet environment.

A mobile device wherein the at least one processor is configured to cause the mobile device to forward an indication of the discreet call or the discreet call to the second device in response to receiving a response that the user is authenticated on the second device and is in the discreet environment.

A remote mobile device comprising: at least one memory, and at least one processor coupled with the at least one memory and configured to cause the remote mobile device to: receive a request to initiate a discreet call with a mobile device associated with a user, transmit the request for the discreet call to the mobile device, and receive an indication that the discreet call is being placed on the mobile device, or receive, from the mobile device, a notification that the user is not in a discreet environment and that the discreet call has been queued.

A remote mobile device wherein the at least one processor is configured to cause the remote mobile device to verify that a discreet call authorization is stored in the at least one memory before transmitting the request for the discreet call, the discreet call authorization authorizing discreet calls between the remote mobile device and the mobile device .

A remote mobile device wherein the at least one processor is configured to cause the mobile device to provide, in response to receiving the notification that the discreet call has been queued, a prompt for sending a text message or an audio message to the remote mobile device when the remote mobile device is subsequently in the discreet environment.

Alternatively, or in addition to the above-described mobile device, any one or combination of:

A method comprising determining, by a mobile device, whether an incoming phone call is a discreet call based on a setting set by a user of the mobile device or a caller of the incoming phone call, determining, using data from one or more sensors of the mobile device, whether a user of the mobile device is in a discreet environment, and in response to determining that the user is in the discreet environment, generating a notification of the discreet call on the mobile device, or in response to determining that the user is not in the discreet environment, queuing the discreet call without generating a notification on the mobile device.

A method wherein queueing the discreet call comprises sending the discreet call to voicemail without ringing.

A method further comprising in response to determining that the user is not in the discreet environment, monitoring an environment around the mobile device to subsequently determine when the user is in the discreet environment, and in response to subsequently determining that the user is in the discreet environment, generating a notification on the mobile device that the incoming discreet call was queued.

A method further comprising in response to determining that the user is not in the discreet environment, sending a verbal or text notification to a remote device that initiated the discreet call that the user is unable to answer the discreet call.

A method wherein determining whether the user is in the discreet environment comprises one or more of: detecting an absence of voices using an audio sensor, detecting an absence of persons using a camera or a radar sensor, detecting an absence of other devices using a wireless communication interface, or analyzing environmental sounds using the audio sensor.

A method wherein thresholds associated with determinations that the user is in the discreet environment are configurable by the user.

A method further comprising: analyzing calendar data associated with the user, and adjusting sensitivity thresholds for determining whether the user is in the discreet environment based on the analyzed calendar data.

A method further comprising: detecting a pattern of environmental conditions when the user typically accepts discreet calls, and using the detected pattern to refine criteria for determining when to generate notifications for incoming discreet calls.

1. A mobile device, comprising:
at least one memory; and
at least one processor coupled with the at least one memory and configured to cause the mobile device to:
determine that an incoming phone call is a discreet call based on a setting set by a user of the mobile device or a caller of the incoming phone call;
determine, using data from one or more sensors of the mobile device, whether a user of the mobile device is in a discreet environment; and
in response to a determination that the user is in the discreet environment, generate a notification of the discreet call on the mobile device; or
in response to a determination that the user is not in the discreet environment, queue the discreet call without generating a visual notification or an audio notification on the mobile device.

2. The mobile device of claim 1, wherein the at least one processor is configured to cause the mobile device to:
in response to queueing the discreet call, subsequently determine whether the user is in the discreet environment using data from the one or more sensors; and
in response to a subsequent determination that the user is in the discreet environment, initiate a return call to the caller.

3. The mobile device of claim 1, wherein the at least one processor is configured to cause the mobile device to:
determine a level of privacy of an environment within a predetermined distance around the user based on data from the one or more sensors; and
adjust notification settings for the discreet call based on the determined level of privacy.

4. The mobile device of claim 1, wherein the at least one processor is configured to cause the mobile device to send a notification to the caller that the user is unable to answer the discreet call in response to queueing the discreet call.

5. The mobile device of claim 4, wherein the notification is sent to the caller in response to the caller being previously identified by the user as a trusted individual or a favorite contact.

6. The mobile device of claim 4, wherein the at least one processor is configured to cause the mobile device to generate a discreet visual notification of queuing of the discreet call in response to receiving a notification from the caller that the discreet call is urgent or an emergency phone call.

7. The mobile device of claim 1, wherein the at least one processor is configured to cause the mobile device to:
determine, using the one or more sensors, whether the user is authenticated on the mobile device; and
in response to a determination that the user is authenticated on the mobile device, determine whether the user of the mobile device is in the discreet environment; or
in response to a determination that the user is not authenticated on the mobile device, send a request to a second device associated with the user to determine whether the user is authenticated on the second device and is in the discreet environment.

8. The mobile device of claim 7, wherein the at least one processor is configured to cause the mobile device to forward an indication of the discreet call or the discreet call to the second device in response to receiving a response that the user is authenticated on the second device and is in the discreet environment.

9. A method comprising:
determining, by a mobile device, whether an incoming phone call is a discreet call based on a setting set by a user of the mobile device or a caller of the incoming phone call;
determining, using data from one or more sensors of the mobile device, whether a user of the mobile device is in a discreet environment; and
in response to determining that the user is in the discreet environment, generating a notification of the discreet call on the mobile device; or
in response to determining that the user is not in the discreet environment, queuing the discreet call without generating a notification on the mobile device.

10. The method of claim 9, wherein queueing the discreet call comprises sending the discreet call to voicemail without ringing.

11. The method of claim 9 further comprising:
in response to determining that the user is not in the discreet environment, monitoring an environment around the mobile device to subsequently determine when the user is in the discreet environment; and
in response to subsequently determining that the user is in the discreet environment, generating a notification on the mobile device that the incoming discreet call was queued.

12. The method of claim 9 further comprising:
in response to determining that the user is not in the discreet environment, sending a verbal or text notification to a remote device that initiated the discreet call that the user is unable to answer the discreet call.

13. The method of claim 9, wherein determining whether the user is in the discreet environment comprises one or more of:
detecting an absence of voices using an audio sensor;
detecting an absence of persons using a camera or a radar sensor;
detecting an absence of other devices using a wireless communication interface; or
analyzing environmental sounds using the audio sensor.

14. The method of claim 13, wherein thresholds associated with determinations that the user is in the discreet environment are configurable by the user.

15. The method of claim 9, further comprising:
analyzing calendar data associated with the user; and
adjusting sensitivity thresholds for determining whether the user is in the discreet environment based on the analyzed calendar data.

16. The method of claim 9, further comprising:
detecting a pattern of environmental conditions when the user typically accepts discreet calls; and
using the detected pattern to refine criteria for determining when to generate notifications for incoming discreet calls.

17. A remote mobile device, comprising:
at least one memory; and
at least one processor coupled with the at least one memory and configured to cause the remote mobile device to:
receive a request to initiate a discreet call with a mobile device associated with a user;
transmit the request for the discreet call to the mobile device; and
receive an indication that the discreet call is being placed on the mobile device; or
receive, from the mobile device, a notification that the user is not in a discreet environment and that the discreet call has been queued.

18. The remote mobile device of claim 17, wherein the at least one processor is configured to cause the remote mobile device to verify that a discreet call authorization is stored in the at least one memory before transmitting the request for the discreet call, the discreet call authorization authorizing discreet calls between the remote mobile device and the mobile device.

19. The remote mobile device of claim 17, wherein the at least one processor is configured to cause the mobile device to provide, in response to receiving the notification that the discreet call has been queued, a prompt for sending a text message or an audio message to the remote mobile device when the remote mobile device is subsequently in the discreet environment.

20. The remote mobile device of claim 17, wherein the at least one processor is configured to cause the mobile device to prompt the user to indicate the discreet call is an emergency or urgent phone call in response to receiving the notification that the user is not in the discreet environment.
